(19) United States
(12) Patent Application Publication
(10) Pub. No.: US 2019/0297298 A1
(43) Pub. Date: Sep. 26, 2019

(54) SYNTHETIC ELECTRONIC VIDEO CONTAINING A HIDDEN IMAGE

(71) Applicant: ECOLE POLYTECHNIQUE FEDERALE DE LAUSANNE (EPFL), Lausanne (CH)

(72) Inventors: Sami ARPA, Lausanne (CH); Sabine SÜSSTRUNK, Lausanne (CH); Roger D. HERSCH, Epalinges (CH)

(21) Appl. No.: 15/934,113

(22) Filed: Mar. 23, 2018

(51) Int. Cl. H04N 5/74; G03B 21/26; H04N 1/32; H04N 21/414

(52) U.S. Cl. CPC H04N 5/74; G03B 21/26; H04N 2005/91392; H04N 21/41415; H04N 1/32149

(57) ABSTRACT

We present a method for hiding images in synthetic videos and reveal them by temporal averaging. We developed a visual masking method that hides the input image both spatially and temporally. Our masking approach consists of temporal and spatial pixel by pixel temporal variations of the frequency band coefficients representing the image to be hidden. These variations ensure that the target image remains invisible. In addition, by applying a temporal expansion function derived from a dither matrix, we allow the video to carry a visible message that is different from the hidden image. The image hidden in the video can be revealed by software averaging, or with a camera, by long exposure photography. The method finds applications in the secure transmission of digital information.

### BACKGROUND OF THE INVENTION

The present invention is related to the field of video steganography, watermarking, digital video copyright protection methods and devices and, more particularly, to methods and security devices for electronic document authentication and video copyright protection.

In the following disclosure, non-patent publications are cited by a number, e.g. [1], which refers to the section “Cited non-Patent Publications” at the end of the description.

Electronic documents are today used in many forms such as e-bills, e-tickets, and e-identity cards. Many people are holding such digital documents on their computers and smart phones instead of printing them. For example, in the airports, people prefer scanning their boarding passes through their smartphones. Even if these documents are stored digitally, most of them have intermediate security features that are designed for the printed versions. The possibility of counterfeiting these documents digitally creates an important problem due to the availability of digital tools and image manipulation software. In a close future, many documents will be stored and processed electronically on smartphones and tablet screens. In this context, the present invention discloses a new secure document encoding and authentication method for documents that are presented on the screens to the authorities.

Video copyright protection is a very important problem in the movie industry. Movie revenues decline because of pirating. Movie pirates can copy an original movie from different sources.

One method is to directly copy the movie (e.g DCP) that is projected in the movie theatres. The second method is ripping of DVDs or Blu-rays. The third method is direct copy of the movie on demand platforms such as Netflix, Amazon Prime, and Hulu. After copying, these movies are distributed illegally on the streaming platforms. For preventing all three methods, it is important to detect the identity of the pirate and the source of piracy. The present invention can be used as a video seal within the title or credits section of the movies. The video seal secretly transfers the identity of each person and organisation that distributes the medium. Once the movie is found in the other streaming platforms, the origin of the piracy can be detected easily through this video seal by using a conventional camera.

Steganography is a technique used for secret communication. The hidden message and visible content can be unrelated. The main concern of steganography is the undetectability of the hidden content. Many steganography methods act on the spatial domain of the image [1,2]. In many methods, the hidden content is embedded by changing the least significant bits of pixel values. Embedding at the spatial level is sufficient to deceive the human visual system. However, the resistance of these methods to attacks are weak. More advanced methods in steganography uses the spatial frequency domain where embedding is performed at the cosine transform level [3,4]. McKeon [5] shows how to use the discrete Fourier transform for steganography in movies. Some adaptive steganography methods consider the statistics of image features before embedding the message. For example, the noisy parts of an image are more suitable for embedding than the smooth parts [6].

Digital watermarking is used for the protection of digital content. Different than steganography, the visible content is more important than the hidden content. The strength of watermarking methods is related to the difficulty of removing hidden content from the visible content. The watermark aims at marking the digital content with an ownership tag. Copyright protection, fingerprinting to trace the source of illegal copies, and broadcast monitoring are the main purposes of digital watermarking [7]. In reversible watermarking techniques, a complete restoration of the visible content is possible with the extraction of the watermark [8]. Several approaches use lossless image compression techniques to create space for the watermarking data [9,10]. Although many different algorithms are used, the main goal of all reversible watermarking methods is the same: avoiding damaging sensitive information in the visible content and enabling a full extraction of the watermark and original data. For the extraction of the watermark, a retrieval function is required. Complex embedding functions result in complex retrieval functions requiring special software. This is one of the disadvantages of digital watermarking techniques. Although they provide a high level of security, the originality cannot be controlled rapidly.

Many patents exist in the video watermarking and steganography domains. U.S. Pat. No. 6,557,103 to Boncelet et. al. presents a data hiding steganographic system which uses digital images as a cover signal embeding information to least significant bits in a way that prevents humans to recognize it visually. In some inventions, multiple bit auxiliary data is embedded into the video that can only be decoded with an intermediate function (U.S. Pat. No. 20,070,223,592 to Rhoads). U.S. Pat. No. 6,559,883 to Fancher et. al. presents a system specifically for preventing movie piracy in movie theaters. The system is formed by an encoding system generating infrared pattern and a display showing it. A human observer viewing this display cannot recognize infrared patterns but once the display is recorded by a camera, the infrared patterns become visible. U.S. Pat. No. 20,090,031,429 to Zeev creates a predetermined pattern in the unreadable part of the storage medium which is configured to be only perceived by a media reader having a special setup. This allows only authenticated people to read the media files. Another invention (U.S. Pat. No. 6,529,600 to Epstein and Stanton) presents a method and device against movie piracy that varies frequently the frame rate, line rate, or pixel rate of the projector.

Our method is not directly competing with conventional watermarking and steganography. We generate synthetic video seals hiding visual information that can be revealed with a standard camera. We present a complicated encoding method but a very simply decoding method. Most stenographic methods use very complex decoding procedures. In contrast, our method aims at revealing information without using any decoding algorithm, i.e. by long exposure photography. Therefore, the present invention differs strongly from existing visual watermarking or steganography methods.

By exploiting the limitations of the human visual system with respect to the temporal domain, we design an algorithm for creating special synthetic video seals, that we call tempocodes. Such a synthesized video either appears as spatial noise or carries a visible message different from the hidden one. If the correct exposure time is set, the hidden image is revealed by a camera.

### SUMMARY

The present invention discloses a method of hiding an image into a synthetic video that is generated from that image by applying an expansion function. This function expands the image intensity values of pixels in the time domain by varying them from the original intensity values but still ensuring that the integration of the variations over time yields the original intensity values. The hidden image does not appear neither spatially on the frames of synthetic video (e.g. by pausing the video to check a current frame), nor by the eye integrating successive frames temporally (e.g. by a human watching the video on a video player).

The encoding technique is complex. It includes a multi-frequency decomposition operation with three possible temporal expansion functions. A first encoding technique consists in generating the synthetic video with a random function in the multi-frequency domain, resulting in spatially and temporally varying noise. The second encoding technique creates the synthetic video in the form of a sinusoidal wave in the multi-frequency domain that appears as spatial noise evolving smoothly in time. The third encoding technique enables generating synthetic videos combining multi-frequency domain decomposition, random expansion function and dithering function, yielding smoothly varying tiny structures having the form of symbols, graphic elements, shapes, text, or images.

The decoding technique is very simple and differs from watermarking methods. The presented expansion function ensures that the integration of the synthetic video, i.e. the average over the successive frames, yields the original hidden image. This enables revealing hidden images by using conventional cameras having an adjustable exposure time feature. Once the exposure time is set according to the duration of the video, taking a photo of the video that is running on the display reveals the hidden image.

One advantage of the present invention is that the hidden image cannot be revealed by the human eye even if the video is observed with at high or low frame rates. The human visual system has the ability of averaging the successive frames within a time interval of about 40 ms. This enables the perception of smooth motion in videos. When our synthesized videos are displayed on displays having a high frame rate, there is a danger of revealing the hidden image because of the temporal integration capability of the human eye. However, because of the decomposition of the image to be hidden into frequency bands and the expansion with variable amplitude signals, the hidden content is not revealed, even when watching the video on a very high frame rate display.

A further aspect of the present invention is a method to generate synthetic videos hiding the image in multi-colour. To generate multi-colour videos, the expansion function is applied to each colour channel separately in the multi-frequency domain.

Synthetic videos that are generated by the present invention can be used as a security feature in electronic documents such as electronic tickets and identification cards. Another usage of the present invention is against movie piracy. These synthetic videos hiding the identity of the movie customer can be embedded in the credits or title sections of movies or videos. In case of illegal distribution of such a movie, the video seal will facilitate the identification of the pirate distributing the movie illegally.

One aspect of the invention is directed to a method for generating, in a computing system, a synthetic electronic video comprising a plurality of sequential video frames containing a hidden image that is not ascertainable by the naked eye of a human observer when the video is played on an electronic display, the method comprising the steps of:
(a) providing an electronic file of the hidden image and decomposing the hidden image into a plurality of spatial frequency bands;
(b) applying to pixels of said spatial frequency bands an expansion function that yields temporally varying instances of said spatial frequency bands, which, when averaged, enable recovering said spatial frequency bands;
(c) summing at each time point the corresponding instance from each of the expanded spatial frequency bands to generate said video frames in which said hidden image is contained.

The invention method may further include a method of recovering the hidden image comprising: (d) averaging said plurality of sequential video frames and recovering thereby the hidden image.

Step d) may be performed by a camera that captures the video played on an electronic display and combines the plurality of sequential video frames into a still image that reveals the hidden image.

The electronic display may be a device selected from a set of TV, computer display, tablet, smartphone, and smart watch.

In an advantageous embodiment, the expansion function may be selected from the set of
(i) random functions that generate both spatial and temporal noise,
(ii) sinusoidal composite wave functions that generate spatial random noise evolving smoothly in time,
(iii) combination of random and dither expansion functions, where the dither expansion function relies on a dither matrix animated in time.

In an advantageous embodiment, the camera is selected from a set of
(i) a camera that captures the plurality of sequential video frames as a single image within an adjustable exposure time and (ii) a camera that captures the plurality of sequential video frames and averages them by software.

In an advantageous embodiment, the method includes, before or during step (a), reducing the contrast of the hidden image, and after step (d) increasing the contrast of the recovered hidden image.

In an advantageous embodiment, the expansion function may be applied to each color channel separately to generate said synthetic video in color.

The method according to an aspect of the invention may further include embedding the synthetic electronic video within a classical video or movie.

A further aspect of the invention is directed to a computing system operable for generating a synthetic electronic video comprising a plurality of sequential video frames containing a hidden image that is not ascertainable by the naked eye of a human observer when the video is played on an electronic display, said computing system comprising software modules operable for:
(a) decomposing said hidden image into a plurality of spatial frequency bands;
(b) applying to pixels of said spatial frequency bands an expansion function that yields temporally varying instances which, when averaged, enable recovering said spatial frequency bands;
(c) summing at each time point the corresponding instance from each of the expanded spatial frequency bands to generate said video frames in which said hidden image is contained.

The computing system may further comprise a camera operable for capturing and averaging said synthetic video frames, thereby recovering the hidden image.

A further aspect of the invention is directed to a synthetic electronic video comprising a plurality of video frames containing a hidden image that is not ascertainable by the naked eye of a human observer when the video is played on an electronic display, and wherein the hidden image is revealed by averaging the plurality of video frames of said video.

The synthetic electronic video may advantageously be embedded within a classical video or movie.

In an advantageous embodiment, the hidden image does not appear in any single video frame.

In an advantageous embodiment, the synthetic electronic video comprises a dynamically evolving message different from the hidden image, where said dynamically evolving message comprises a visual element selected from the set of text, logo, graphic element, and picture.

### BRIEF DESCRIPTION OF THE DRAWINGS

For a better understanding of the present invention, one may refer by way of example to the accompanying drawings, in which:

synthetic FIG. 1 shows a tempocode video where the hidden information can be revealed through long exposure photography of the video;

FIG. 2 shows an overview of the technique that generates a tempocode video from a given input image I;

FIG. 3 shows an example of a discontinuous random function ƒ (t) applied to mask an image to be hidden;

FIG. 4A shows the integration of a modulated wave for the given target intensity I_{c}^{l}(x,y) (414) where for each of the 4 parent sample p₁, p₂, p₃, p₄ a simple sinusoidal is generated by ensuring that its integration yields the parent sample;

FIG. 4B shows the continuous signal 420 after applying the refinement on the signal 413 of FIG. 4A to remove discontinuities 413a, 413b, and 413c;

FIG. 5A shows the trajectory of dither matrix cells resulting from the animation of the dither matrix along a certain direction;

FIG. 5B shows the succession of dither thresholds for a pixel over time that is created by the animation of the dither matrix and FIG. 5C shows the corresponding final pixel intensity values whose average yields the target intensity 515;

FIG. 6 shows a comparison of 3 different expansion functions for the same input image and their averages over 4 frames on the right top corner of the frames;

FIG. 7 shows sample tempocode frames generated with different input images and dither matrices;

FIG. 8 shows the usage of a tempocode in movies; and

FIG. 9 shows a computing system that generates tempocodes.

### DETAILED DESCRIPTION OF EMBODIMENTS OF THE INVENTION

The goal of the present work is to hide an image in a video stream under the constraint that the temporal average of the video reveals the image. Specifically, the input image should remain invisible in each frame of the video and should not become visible due to the temporal integration of consecutive frames by the human visual system (HVS). In order to achieve this, a visual masking method that acts both in the spatial and in the temporal domain is required. Spatial masking inhibits orientation and frequency channels of the HVS. In temporal masking, any information coming from the target image by temporal averaging should be masked.

Our method hides an input image within a video. The image is revealed by averaging, which is either achieved by pixelwise mathematical averaging of the video frames or by long exposure photography. We call the video hiding the input image “tempocode” or equivalently “tempocode video”.

Regarding the vocabulary, we also call the image to be hidden within the tempocode video “target hidden image” or simply “target image”. Sometimes we refer to one pixel called “target pixel” of the target image or of an instance of the target image that has been obtained by processing it, for example by decomposition into frequency bands. A target pixel has a “target intensity value” or simply a “target intensity”. In analogy with the science of signal processing, the term “target signal” or simply “target” is used for the signal to be hidden. In the present disclosure, there is an implicit analogy between the term “target signal” and “target image” or between “target signal” and “target image pixel”.

FIG. 1 shows a tempocode 11 that is playing on a display device 12 e.g. a monitor, a TV, a tablet, or a smart phone. The hidden image 14 can be revealed with a camera 13 by setting the predefined exposure time, which in the general case is between 2 seconds and 20 seconds.

In order to create such tempocodes, we apply the following self-masking approach. We first decrease the dynamic range of the input image and decompose it into a certain number of frequency bands. For each frequency band of the contrast reduced input image, we generate temporal samples by sampling a selected expansion function, whose integration along a certain time interval gives the corresponding frequency band. We then reconstruct each video frame from the temporal samples derived from the frequency bands. We consider the following expansion functions: random function, sinusoidal composite wave function, and a temporally-varying dither function. Using these functions we generate different masking effects such as smoothly evolving videos and videos with visible moving patterns.

We now describe our approach for hiding an image in a video. The hidden information is not perceivable by the human eye but the pixelwise average of the video over a time interval ranging between 2 seconds and 20 seconds reveals the hidden image. With the correct exposure time, conventional and digital cameras can detect the hidden information. Software averaging over the video frames also reveals the image.

The main challenge resides in masking the input image by spatio-temporal signals that are a function of the input image. To achieve this, we present a visual masking process that enables hiding the input image for both the spatial and the temporal perception of human beings.

In conventional visual masking methods, the mask and the target signal to be hidden are different stimuli. However, in our method, the mask is constructed from the target image. We call this approach “self-masking”.

We initially define the problem in the continuous domain. A constant target signal p is reproduced by the integration of ƒ(t), a time dependent expansion function, over a duration τ:

$$p = \frac{1}{τ} {\int }_{0}^{τ} f ( t + δ ) dt \qquad ( 1 )$$

In order to create spatial noise, a phase shift parameter δ is selected randomly at each spatial position. We assume that the display is linear. The target signal p, the duration τ, and the phase shift δ are known parameters. The challenge resides in finding a function ƒ(t+δ), satisfying this integration and ensuring that the target signal is masked at each time and within each small time interval (˜40 ms). We present the different alternatives for the expansion function ƒ(t+δ) in the “Expansion Functions” section.

In practice, our signals are not continuous since the target image to be hidden is a digital image and the mask is a digital video designed for modern displays. Let I be a target image to be masked (i.e. hidden) into a video V having n frames. Initially, we reduce the contrast of the input image I by linear scaling and obtain the contrast reduced image I_{c}. This is required in order to reach the masking threshold, i.e. the threshold where the target image is hidden.

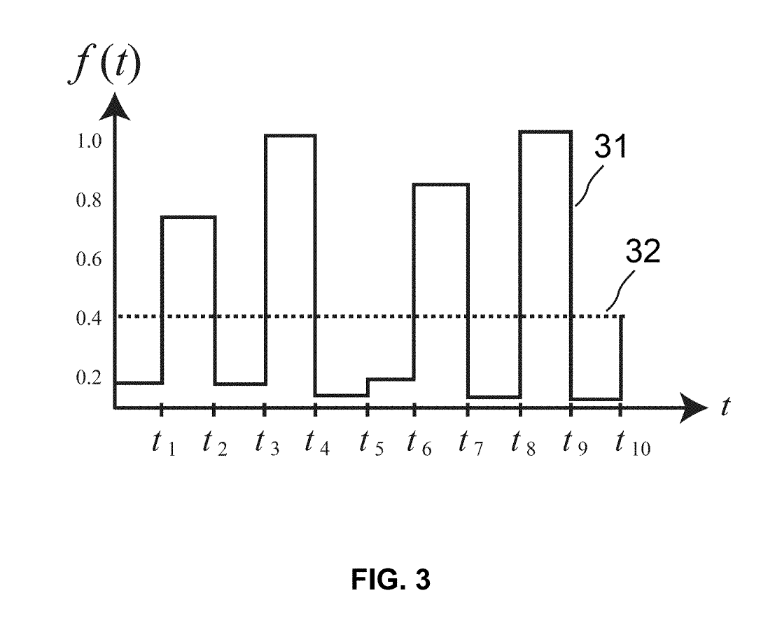

A multi-band masking approach is required to mask both high frequency and low frequency target image contents. Applying the expansion function solely on input pixels would only mask the high frequency content. Therefore, we decompose the contrast reduced target image I_{c} into spatial frequency bands. A Gaussian pyramid is computed from the contrast reduced target image I_{c}. To obtain the frequency bands, we compute the differences of every two neighbouring pyramid levels. In practice, we use a standard Laplacian pyramid with a 1-octave spacing between frequency bands, see reference [11] herein incorporated by the reference. Finally, for each contrast reduced pixel value I_{c}^{l}(x,y) in each band l, we solve a discretized instance of Eq. (1). Let t₁, . . . tₙ be a set of n uniformly spaced time points (FIG. 3) representing the time points at which tempocode video frames are generated (marked by ticks on the horizontal axis in FIGS. 3, 4A, 4B, 5B, 5C). Then the integral in Eq. (1) is approximated as follows:

$$\begin{matrix}{I}_{c}^{l} ( x , y ) = \frac{1}{n} {\sum }_{i = 1}^{n} {v}_{i}^{l} ( x , y ) & ( 2 ) \\ {v}_{i}^{l} ( x , y ) = f ( {t}_{i} + {δ}_{l} ( x , y ) ) & ( 3 )\end{matrix}$$

where vᵢ^{l}(x,y) is the frame Vᵢ of frequency band l at time point tᵢ of the resulting video and where (x,y) indicates the pixel location. A different phase shift value δₗ is assigned to each pixel (x,y) in each band l.

Once all bands vᵢ^{l}(x,y) of each frame vᵢ(x,y) are constructed, we sum the corresponding bands to obtain the final frame at time point tᵢ:

$${v}_{i} ( x , y ) = {\sum }_{l = 1}^{k} {v}_{i}^{l} ( x , y ) \qquad ( 4 )$$

where k is the number of bands and (x,y) is the position of a given pixel within the frame.

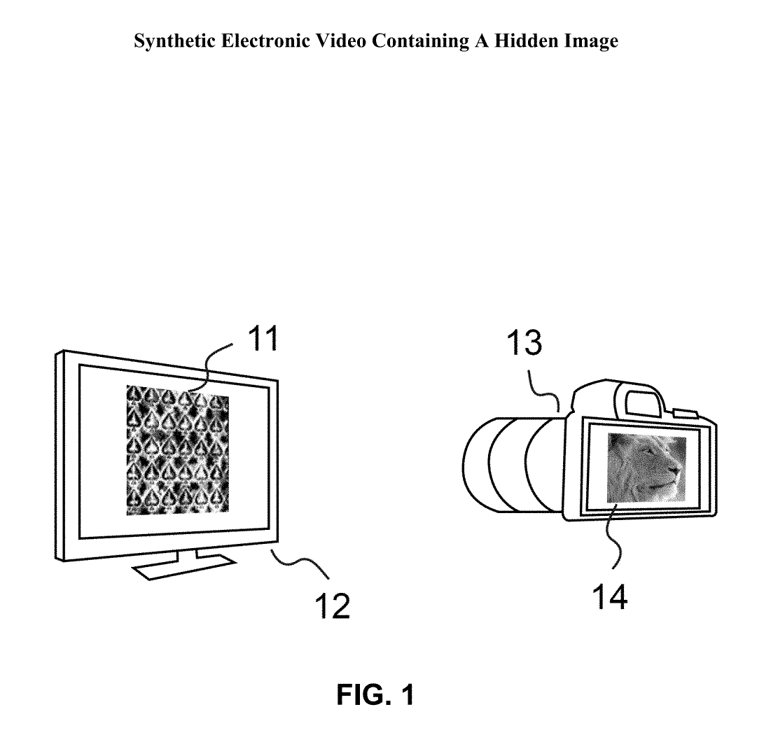

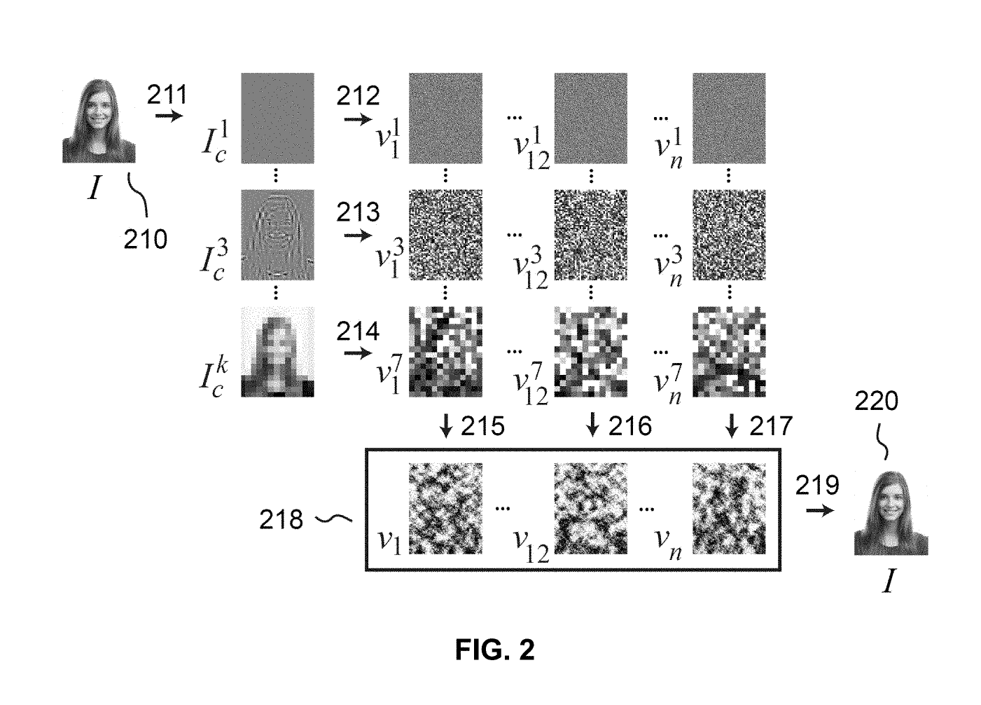

FIG. 2 shows an overview of the method. A tempocode 218 is generated from the contrast reduced instance I_{c} of an input image I 210. The contrast reduced input image is decomposed into frequency bands 211. Then, a temporal expansion function 212, 213, 214 is applied on each frequency band image I_{c}^{l} to generate n video frames for each band l. The frames having the same temporal index from the different bands vᵢ^{l}(x,y) are then summed 215, 216, 217 to generate the final tempocode video frames 218. This tempocode is the video hiding the image I.

For decoding purposes, the average of the tempocode frames 219 gives the contrast reduced input image I_{c} from which the input I 220 is recovered. In the present example, the resulting video has n=24 frames and is constructed with k=7 frequency bands. In FIG. 2, only 3 frames and 3 frequency bands are shown for illustrative purposes.

### Contrast Reduction for Masking Purposes

A masking signal with a certain contrast can mask a target signal having a contrast smaller than the masking threshold. In the present invention, we always generate our mask with 100 percent contrast in order to enable a maximal contrast of the target image to be hidden. To ensure that the target image is hidden, we first reduce the contrast of the target image I and move the contrast reduced image to the center of the available intensity range. The resulting contrast reduced image I_{c} is:

$${I}_{c} ( x , y ) = α \cdot I ( x , y ) + \frac{1}{2} - \frac{α}{2} \qquad ( 5 )$$

where α is the reduction factor and 0<α<1.

The amount of contrast reduction a depends on the contrast, spatial frequency, and orientation of the image to be hidden.

It is very important to select the correct contrast reduction factor α to reach the masking threshold. However, the input image consists of a mixture of locally varying contrasts, spatial frequencies, and orientations that affect masking. The contrast reduction factor α should be selected by considering the local image element that requires the largest amount of the contrast reduction. Once this image element is masked, all other image elements are masked as well.

### Expansion Functions

Many different types of temporal expansion functions ƒ(t+δ) fulfill the requirements of Eq. (1). We can define a random function with uniform probability, a Gaussian function, a Bezier curve, a logarithmic function, or periodic functions such as a square wave, a triangle wave, or a sine wave. However, the following constraints need to be satisfied:
Eq. (1) must have a solution for the selected function within the dynamic range of each frequency band.
Masking must be achieved spatially and temporally during the whole video V. In other words, any visual element that could reveal the target image I or its contrast reduced instance I_{c} must remain invisible to the human eye.
A smooth transition between frames is desirable. Therefore, we want our function to be continuous.

In the following, we describe random, periodic, and dither expansion functions.

### 1. Random Expansion Function

Our random expansion function is made of n random uniformly distributed samples varying temporally for each pixel of each band (FIG. 3, t₁, . . . , tₙ). The mean of this uniform distribution is given by the intensity I_{c}^{l}(x,y) of the corresponding pixel of band l. Eq. 2 holds with an error that depends on the number of samples. If the number of samples is small, the error becomes larger. To enforce Eq. 2, we redistribute the error over all samples. Besides, the samples whose values are out of the allowed range are clipped. The remainders are redistributed equally to the other samples. This process is repeated until all samples are within the allowed range.

If the contrast of the target image is sufficiently reduced, the random function masks to a large extent the target image. However, this is only true when each frame is observed separately. When all frames are played as a video (e.g., at 30 frames per second), the target image might be slightly revealed. This is due to the fact that the target image is well masked spatially but not temporally. The human visual system has a temporal integration interval of 40±10 ms. Therefore a few consecutive frames can be averaged by the human visual system.

FIG. 3 shows a signal 31 that is generated with the random function ƒ(t) to mask a pixel I_{c}^{l}(x,y) of a band l of the target image. The integration of the signal gives the target intensity of that pixel 32. If we look at the random signal 31, the average of any two consecutive values has a value close to the target pixel intensity I_{c}^{l}(x,y). A low frequency expansion function is therefore required to ensure temporal masking within time intervals between 20 ms and 60 ms.

### 2. A Sinusoidal Composite Wave

As we have seen in the previous section, a temporally continuous low frequency masking signal is required to avoid revealing the target signal by temporal integration of the human visual system. We thus propose a periodic function that results in spatial discontinuity and temporal continuity of the resulting video.

We use a sine function as our periodic function. Spatial juxtaposition of phase-shifted sine functions may reveal local parts of the target image. Therefore, instead of using a regular sine function, we create a sinusoidal composite wave by varying the function in amplitude for a given number of temporal segments.

In order to create m sine segments varying in amplitude, we first generate m uniformly distributed random temporal parent-samples pⱼ^{l}(x,y) for each pixel of each band ensuring that their mean is I_{c}^{l}(x,y):

$${I}_{c}^{l} ( x , y ) = \frac{1}{m} {\sum }_{j = 1}^{m} {p}_{j}^{l} ( x , y ) \qquad ( 6 )$$

Since we have a small number of parent-samples (e.g. 4 samples), the mean I_{c}^{l}(x,y) will not be exactly achieved. Therefore, we redistribute the error across the samples. Next, for each parent-sample pⱼ, we establish a function ƒⱼ(t+δ) in the form of Eq. 1 such that:

$${p}_{j} = \frac{1}{{τ}_{e}^{j} - {τ}_{s}^{j}} {\int }_{{τ}_{s}^{j}}^{{τ}_{e}^{j}} {f}_{j} ( t + δ ) dt \qquad ( 7 )$$

where

$${τ}_{s}^{j} = ( j - 1 ) \cdot \frac{τ}{m}$$

is the start time,

$${τ}_{e}^{j} = j \cdot \frac{τ}{m}$$

is the end time, j∈[1, . . . , m] is the index of each parent-sample, and i is the total duration of the video to be averaged.

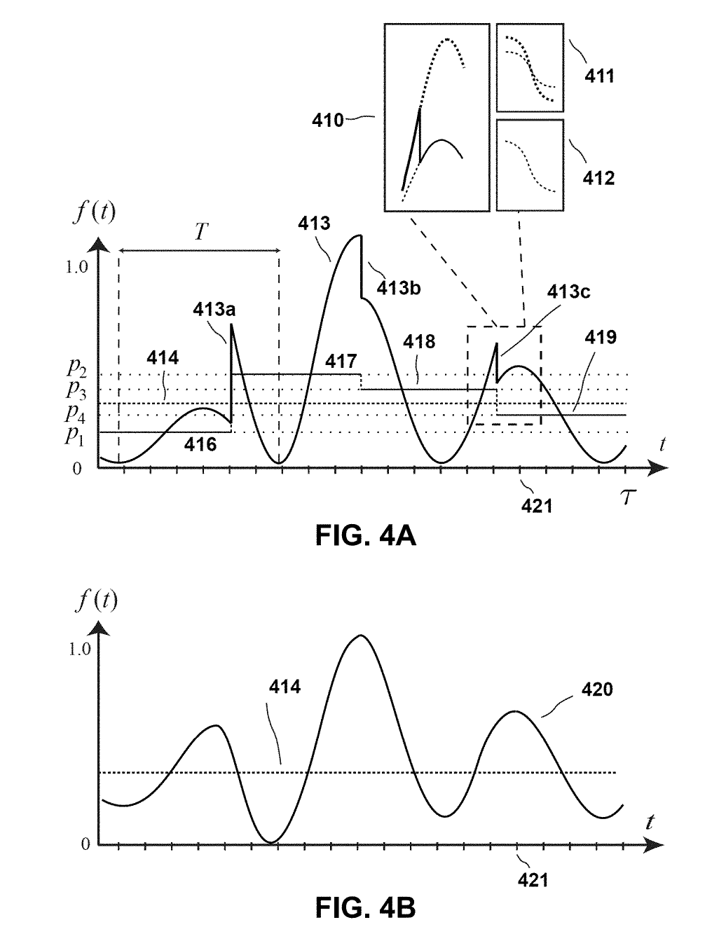

We define the expansion function ƒ₁(t+δ) for each parent sample as a continuous section of a sine in a form that is analytically integrable and lies within the allowed intensity range for most of its values.

$${f}_{j} ( t + δ ) = {k}_{j} \cdot sin ( 2 π \frac{t}{T} + δ ) + {k}_{j} \qquad ( 8 )$$

where kⱼ is the amplitude and T is the period. As shown in FIG. 4A, the period T and the duration of video i have different values. The total duration i of the video is given by the user.

By inserting Eq. 8 into Eq. 7, we can express kⱼ in function of the other parameters:

$${k}_{j} = \frac{{p}_{j} ( {τ}_{e}^{j} - {τ}_{s}^{j} )}{{τ}_{e}^{j} - {τ}_{s}^{j} + \frac{T ( cos ( \frac{2 {πτ}_{e}^{j}}{T} + δ ) - cos ( \frac{2 {πτ}_{s}^{j}}{T} + δ ) )}{2 π}} \qquad ( 9 )$$

For each pixel of each frequency band, these m functions ƒⱼ(t+δ) of parent samples p₁ 416, p₂ 417, p₃ 418, p₄ 419 are sampled by

$$\frac{n}{m}$$

video frames 421, see FIG. 4A. The averages are enforced by redistributing the errors over the temporal samples. According to Eq. 7, the average of each sinusoidal section gives the value of a parent sample. Thus, the average of all n samples (FIG.^{∘}4A, signal 413) gives the target intensity of the considered band I_{c}^{l}(x,y), see FIG. 4A, 414.

In order to ensure a phase continuity between the sinusoidal segments, we select the phase shift δ randomly only for the first sinusoidal segment ƒⱼ(t+δ). For all other functions associated to parent samples we use the current phase δ and the current period T. Nevertheless, due to the variations of the amplitudes, we obtain a non-continuous composite signal. These discontinuities 413a, 413b, 413c appear at the junctions between successive sinusoidal segments (see FIG. 4A, 410) and would be visible in the final output video.

To remove the discontinuities at the junction points, we apply a refinement process by using differential values. From the samples of the composite wave, we first calculate the differential values by taking the backward temporal differences: Δvᵢ^{l}(x,y)=vᵢ^{l}(x,y)−vᵢ₋₁^{l}(x,y) (FIG. 4A, 411). We then blend the differential values of the end part of a sinusoidal segment with those at the starting part of the following sinusoidal segment (FIG. 4A, 412).

With the blended differential values, we re-calculate the intensity values for each pixel of each band by minimizing the following optimization function:

$$E ( {v}_{1}^{l} , … , {v}_{n}^{l} ) = {\sum }_{i = 1}^{n} {‖ {{Δ v}_{i}^{l} ( x , y )}^{′} - {Δ v}_{i}^{l} ( x , y ) ‖}^{2} + {‖ {I}_{c}^{l} ( x , y ) - \frac{1}{n} {\sum }_{i = 1}^{n} {{v}_{i}^{l} ( x , y )}^{′} ‖}^{2} + {\sum }_{b = 1}^{m} {‖ Δ {{v}_{b}^{l} ( x , y )}^{′} - Δ {v}_{b}^{l} ( x , y ) ‖}^{2} \qquad ( 10 )$$

where n is the total number of frames (FIG. 4A, 421). The first term in the optimization minimizes the square differences between blended differential values Δvᵢ^{l}(x,y) and the differential values Δvᵢ^{l}(x,y)′ of the new intensities in the solution set. The second term is a constraint to guarantee that the overall average I_{c}^{l}(x,y) of the new intensities Δvᵢ^{l}(x,y)′ is still satisfied. The third term preserves the overall shape of the signal, by fixing the center sample of each sinusoidal segment as a constraint. Parameter b represents the index of the center sample for each parent sample.

This optimization is solved as a sparse linear system. We obtain a smooth signal (FIG. 4B, 420).

The deviations from the average I_{c}^{l}(x,y) (FIG. 4B, 48) caused by the optimization are redistributed over the n samples.

As shown in FIG. 4B, the sinusoidal composite wave 420 successfully masks the target signal 414 in both the spatial and temporal domains. The final signal 420 is significantly different from the target signal 414 at most points in the timeline. Furthermore, in most cases, the integration of signal ƒ(t) for a short time interval (a few successive frames) is also different from the original signal 414.

### 3. Temporal Dither Expansion Function

A sinusoidal composite wave enables masking the target image both spatially and temporally. However, the visible part, the tempocode video, does not convey any visual meaning. We thus propose to replace the spatial noise with meaningful patterns. For this purpose, we make use of artistic dither matrices which were described in U.S. Pat. No. 7,623,739 to Hersch and Wittwer, herein incorporated by reference.

When printing with bilevel pixels, dithering is used to increase the number of apparent intensities or colors. A full tone color image can be created with spatially distributed surface coverages of cyan (c), magenta (m), yellow (y), and black (b) inks. The human visual system integrates the tiny c,m,y,k inked and non-inked areas into the desired color.

A dither matrix includes in each of its cell a dither threshold value. These dither threshold values indicate at which intensity level pixels should be inked. Artistic dithering enables ordering these threshold levels so that for most levels the turned-on pixels depict a meaningful shape. We adapt artistic dithering to provide a visual meaning to tempocode videos.

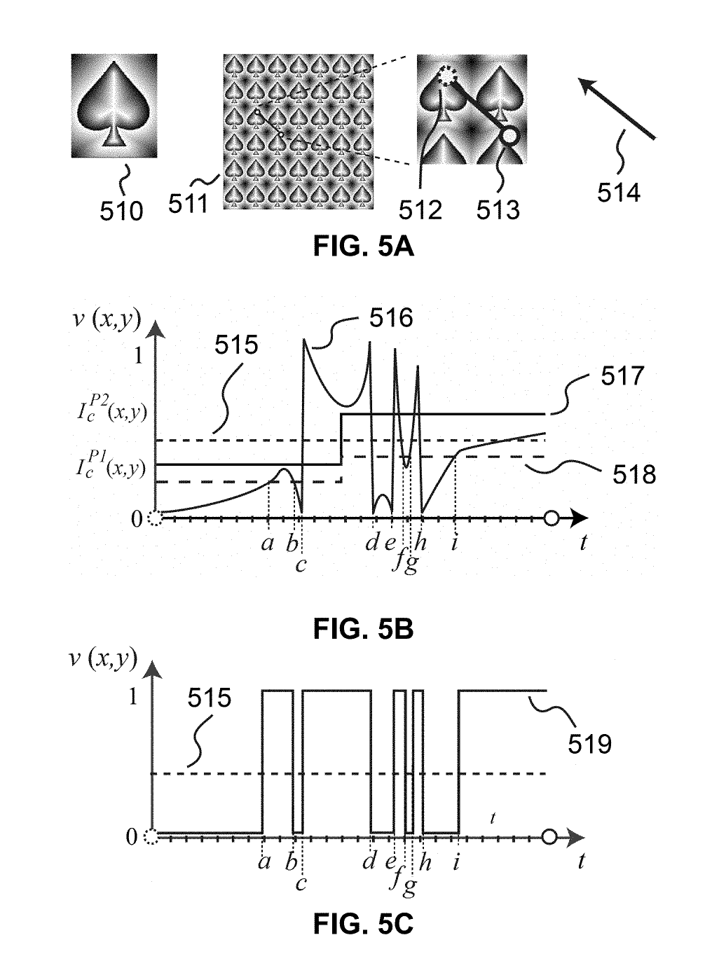

We repeat the selected dither matrix (FIG. 5A, 510) horizontally and vertically to cover the whole frame (FIG. 5A, 511). We then animate the dither matrices. The animation can be achieved by a uniform displacement (FIG. 5A, 514) of the dither matrices at successive frames (FIG. 5A, displacement from 513 to 512). For a single pixel, the threshold values vary over time (FIG. 5B, 516). At any time point of the video, the current dither threshold determines if the pixel is white or black. Accounting for the varying thresholds over time, we can determine a dither input intensity 518 ensuring that the average of the resulting black and white pixels yields the target intensity 515 (Eq. (1)).

Instead of finding such a dither input intensity 518, we directly assign white or black to the successive temporal dither threshold levels as follows:
1. Find the ratio r_{wb} of white to black temporal pixel values to obtain the target intensity I_{c}(x,y). Then derive the number w of white pixel values. This is calculated as follows:

$${r}_{wb} = \frac{{I}_{c} ( x , y )}{1 - {I}_{c} ( x , y )} = \frac{w}{n - w} wtih 0 \leq {I}_{c} ( x , y ) \leq 1 \qquad ( 11 )$$

where n is the total number of frames. Then by solving for w, we obtain

$$w = \frac{n \cdot {r}_{wb}}{1 + {r}_{wb}} .$$

2. For each spatial pixel, sort its succession of dither threshold values that are changing temporally according to the displacement of the dither matrix.
3. Assign the first w temporal intensity values to white and the rest to black.
4. Revert the temporal intensity values back to their original time point indices (i.e. frame number).

A smooth transition between frames is desirable. Therefore, our expansion function should be continuous. This is ensured by the smooth displacement of the dither matrix.

### 4. Combination of Random Expansion and Temporal Dither Expansion Functions

Expansion by simple dithering satisfies one of our conditions, i.e., the average of the frames yield the target image (Eq. (2)). However, a multi-band decomposition cannot be carried out with the dithered binary images since they are bilevel. As shown previously, the multi-band decomposition is an important component for masking the target image. To overcome this problem, we create two parent frames I_{c}^{P1} and I_{c}^{P2} (FIG. 5B, 517) from the input image (FIG. 5B, 515) by applying the random expansion function on each band I_{c}^{l} of image I_{c}, as described in the “Random Expansion Function” Section. The result of the random expansion yields the parent frames 517, as v₁ and v₂ in FIG. 2, 218. For these two parent frames, due to their multi-band decomposition, the target image is masked spatially. Then for each of these two parent frames, we create

$$\frac{n}{2}$$

frames by dither expansion using the temporal dither function as described above. Thanks to the dither expansion we get n dithered frames forming our final video V in which the target image is successfully masked, as shown for a single pixel in FIG. 5C, 519. The creator of a tempocode can freely choose his dither matrix that transmits a visual message (text, graphics, symbols, or photographs).

### Results

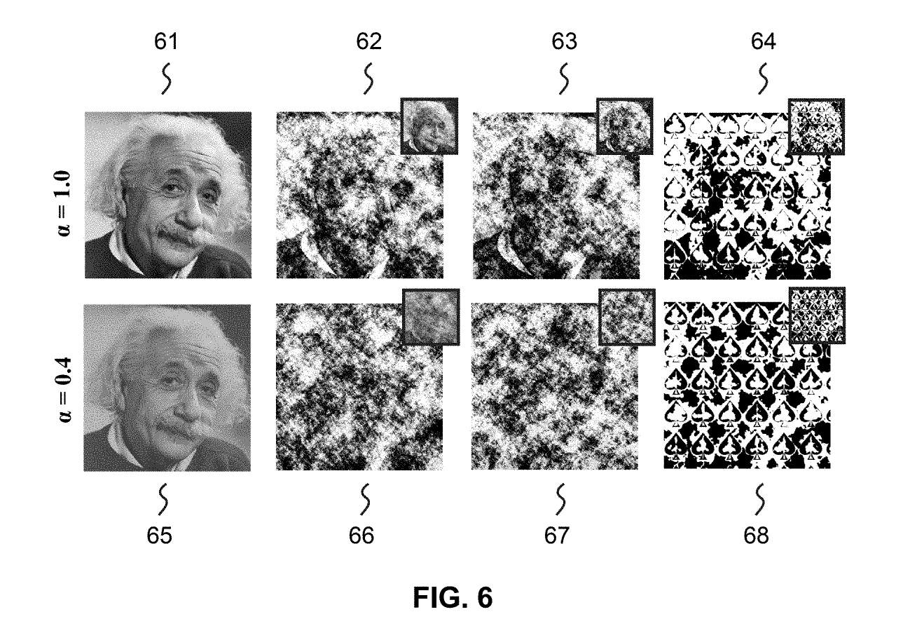

As an example, FIG. 6 shows sample frames from the tempocodes generated with different expansion functions with the following parameters: duration τ=4 s, frame rate=60 fps, period T=1.65 s, and the number of frequency bands k=7. In the top row, the results are generated with a target image having no contrast reduction (α=1.0) 61. None of the functions can fully mask the target image. In the second row, the contrast of the target image is reduced (α=0.4) 65. For a single frame, all functions can mask the target image. However, when a few consecutive frames are averaged by the human visual system temporal integration, the random function 62, 66 reveals the target image. The two other methods, a sinusoidal composite wave 63, 67 and temporal dithering function 64, 68, are able to hide the target image not just spatially but also temporally. The insets on the top-right corner of the frames show the average of four consecutive frames as a simulation of the human visual system temporal integration.

The methods for generating tempocodes are described for grayscale target images. For color images, we use exactly the same procedure and apply the self-masking method to each color channel separately.

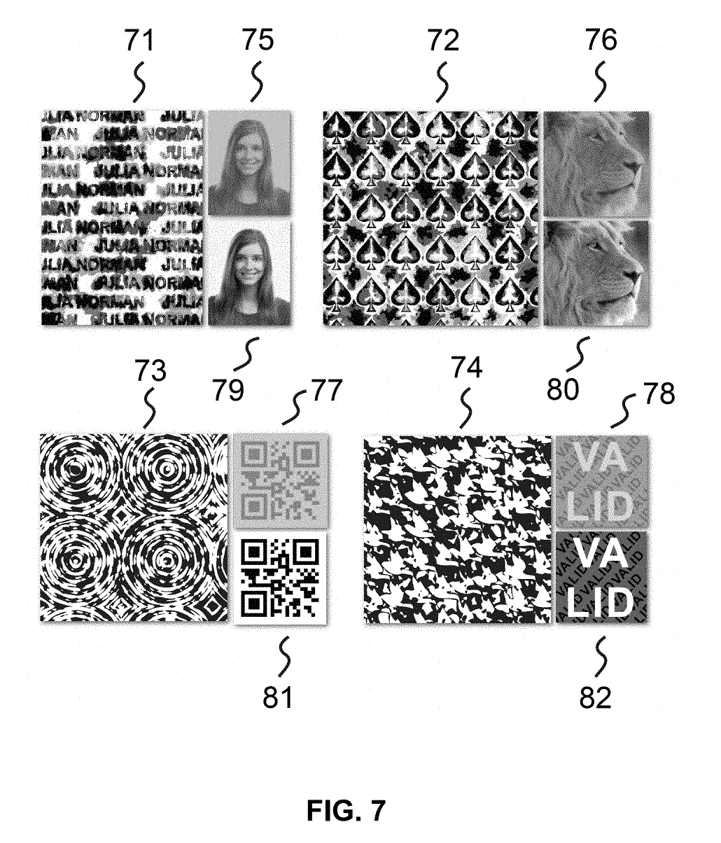

As a further example, FIG. 7 shows sample tempocode frames 71, 72, 73, 74 generated with the different input images 79, 80, 81, 82 and different dither matrices. The hidden images can be revealed by averaging 75, 76, 77, 78. An inverse contrast reduction operation yields the original input image. In all the cases, the target image is recovered by software averaging the tempocode frames. We have the following parameters: for the woman 75, α=0.4; for the lion 76, α=0.5; for the QR code 77, α=0.2; and for the text 78, α=0.3.

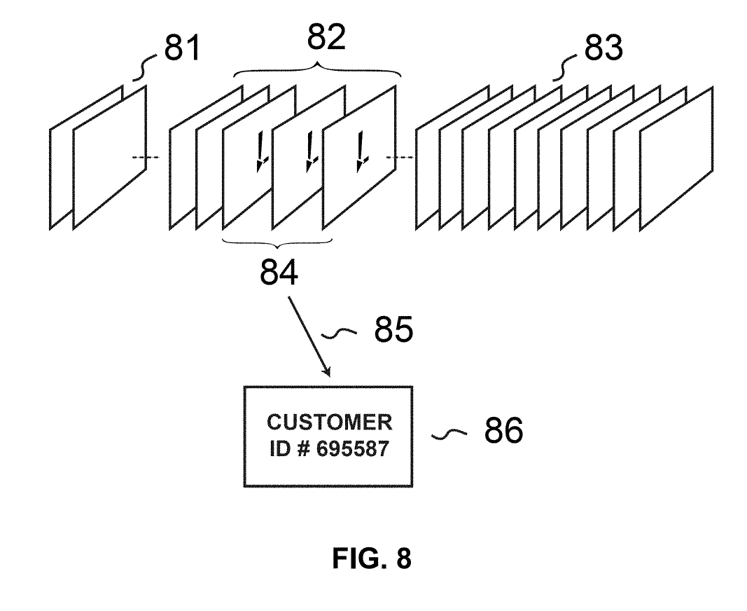

The present invention introduces a screen camera channel for hiding information by simple averaging. The encoding is complex, but the decoding is very simple. Thus, hidden images can be revealed by non-expert users but not created. The present method does not compete with existing watermarking or stenographic methods that require complex decoding procedures. It can be rather used as a first-level secure communication feature. More and more security applications, such as banking software, use smartphones to identify codes that appear on a display. In the present case, instead of directly acquiring the image of a code, the smartphone might acquire a video that incorporates that code. For example, instead of showing a QR code on an electronic document directly, our method can be used to hide it. Hiding a message into a video can be seen as one building block within a larger security framework. Furthermore, tempocodes can be used as video seals in movies against piracy. A video seal can be placed in the credits or titles section (FIG. 8, 84) of the movie (FIGS. 8, 81 to 83). Such video seals can show the logo of the production company in the visible part and the identification number or name of person to which the movie has been distributed to in the hidden part. If the viewer copies and re-distributes the movie illegally, his/her identity can be detected (FIG. 8, 85). by taking a photo (FIG. 8, 84) of the pirated source.

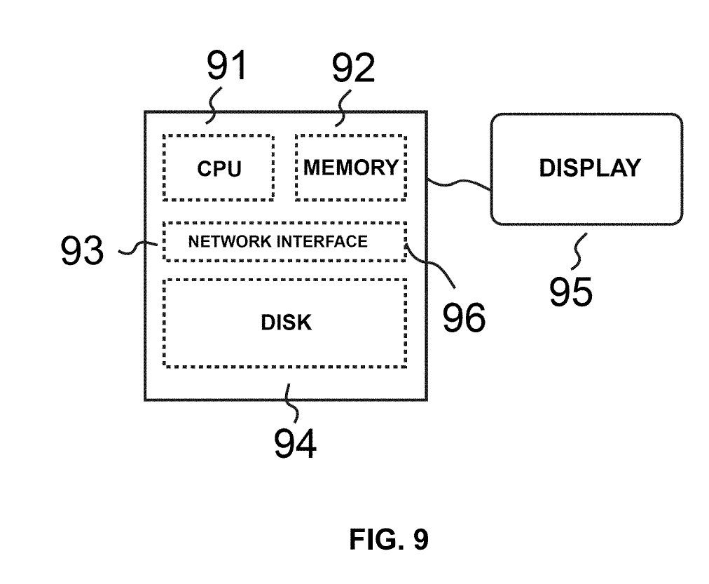

FIG. 9 shows a block diagram of a computing system operable for creating tempocode videos hiding an image. The computing system comprises a CPU 91, memory 92 and a networking interface 93. The space for n video frames is allocated in memory. The video frames of the tempocode video are calculated by software modules running on the CPU. Intermediate frames associated with the different frequency bands as well as the final frames are stored back into memory. The software modules are operable for (a) decomposing the image to be hidden into spatial frequency bands, (b) applying to pixels of said spatial frequency bands an expansion function that yields temporally varying instances which, when averaged, would allow to recover said frequency bands, (c) summing instances of the different frequency bands having the same timecode, yielding thereby synthetic video frames hiding the original hidden image, where the frame by frame summation of said synthetic video frames enables recovering the hidden image.

The final tempocode video is stored on disk 94 or transmitted over the network 96 to another computer in order to be played or to be inserted into a movie. For the display of the tempocode video, a computing system (e.g. TV, laptop, tablet, smartphone, smart watch) with a display 95 is required. The display shows the client's tempocode that has been received through the network or is stored in his memory. Authentication can be performed by an external camera which is not part of this computing system or by an other computing system (e.g. laptop, tablet, smartphone) equiped with a digital camera.

### CITED NON PATENT PUBLICATIONS

1. J. Fridrich, M. Goljan, and D. Hogea, “Steganalysis of jpeg images: breaking the f5 algorithm,” in Information Hiding, (2003), pp. 310-323.
2. Z. Li, X. Chen, X. Pan, and X. Zeng, “Lossless data hiding scheme based on adjacent pixel difference,” in International Conference on Computer Engineering and Technology, (2009), Vol. 1, pp. 588-592.
3. X. Li and J. Wang, “A steganographic method based upon jpeg and particle swarm optimization algorithm,” Inform. Sci. 177, 3099-3109 (2007).
4. A. Hashad, A. S. Madani, and A. E. M. A. Wandan, “A robust steganography technique using discrete cosine transform insertion,” in IEEE International Conference on Information and Communications Technology (2005), pp. 255-264.
5. R. T. McKeon, “Strange Fourier steganography in movies,” in IEEE International Conference on Electro/Information Technology, (2007), pp. 178-182.
6. P. Wayner, Disappearing Cryptography: Information Hiding: Steganography & Watermarking (Morgan Kaufmann, 2009).
7. G. C. Langelaar, I. Setyawan, and R. L. Lagendijk, “Watermarking digital image and video data. A state-of-the-art overview,” IEEE Signal Process. Mag. 17(5), 20-46 (2000).
8. A. Khan, A. Siddiqa, S. Munib, and S. A. Malik, “A recent survey of reversible watermarking techniques,” Inform. Sci. 279, 251-272 (2014).
9. M. Arsalan, S. A. Malik, and A. Khan, “Intelligent reversible watermarking in integer wavelet domain for medical images,” J. Syst. Softw. 85, 883-894 (2012).
10. M. U. Celik, G. Sharma, A. M. Tekalp, and E. Saber, “Lossless generalized-LSB data embedding,” IEEE Trans. Image Process. 14, 253-266 (2005).
11. M. N. Do and M. Vetterli, “Framing pyramids,” IEEE Trans. Signal Process. 51, 2329-2342 (2003).

We claim:

1. A method for generating, in a computing system, a synthetic electronic video comprising a plurality of sequential video frames containing a hidden image that is not ascertainable by the naked eye of a human observer when the video is played on an electronic display, the method comprising the steps of:
(a) providing an electronic file of the hidden image and decomposing the hidden image into a plurality of spatial frequency bands;
(b) applying to pixels of said spatial frequency bands an expansion function that yields temporally varying instances of said spatial frequency bands, which, when averaged, enable recovering said spatial frequency bands;
(c) summing at each time point the corresponding instance from each of the expanded spatial frequency bands to generate said video frames in which said hidden image is contained.

2. The method of claim 1, further including a method of recovering the hidden image comprising:
(d) averaging said plurality of sequential video frames and recovering thereby the hidden image.

3. The method of claim 2, wherein step d) is performed by a camera that captures the video played on an electronic display and combines the plurality of sequential video frames into a still image that reveals the hidden image.

4. The method of claim 3, wherein the electronic display is a device selected from a set of TV, computer display, tablet, smartphone, and smart watch.

5. The method of claim 1, where the expansion function is selected from the set of
(i) random functions that generate both spatial and temporal noise,
(ii) sinusoidal composite wave functions that generate spatial random noise evolving smoothly in time,
(iii) combination of random and dither expansion functions, where the dither expansion function relies on a dither matrix animated in time.

6. The method of claim 3, wherein the camera is selected from a set of
(i) a camera that captures the plurality of sequential video frames as a single image within an adjustable exposure time and (ii) a camera that captures the plurality of sequential video frames and averages them by software.

7. The method of claim 2 wherein before or during step (a) the contrast of the hidden image is reduced and after step (d) the contrast of the recovered hidden image is increased.

8. The method of claim 1, wherein said expansion function is applied to each color channel separately to generate said synthetic video in color.

9. The method of claim 1, further including embedding the synthetic electronic video within a classical video or movie.

10. A computing system operable for generating a synthetic electronic video comprising a plurality of sequential video frames containing a hidden image that is not ascertainable by the naked eye of a human observer when the video is played on an electronic display, said computing system comprising software modules operable for:
(a) decomposing said hidden image into a plurality of spatial frequency bands;
(b) applying to pixels of said spatial frequency bands an expansion function that yields temporally varying instances which, when averaged, enable recovering said spatial frequency bands;
(c) summing at each time point the corresponding instance from each of the expanded spatial frequency bands to generate said video frames in which said hidden image is contained.

11. The computing system of claim 7, further comprising a camera operable for capturing and averaging said synthetic video frames, thereby recovering the hidden image.

12. A synthetic electronic video comprising a plurality of video frames containing a hidden image that is not ascertainable by the naked eye of a human observer when the video is played on an electronic display, and wherein the hidden image is revealed by averaging the plurality of video frames of said video.

13. The synthetic electronic video of claim 12, embedded within a classical video or movie.

14. The synthetic electronic video of claim 12, wherein the hidden image does not appear in any single video frame.

15. The synthetic electronic video of claim 12, comprising a dynamically evolving message different from the hidden image, where said dynamically evolving message comprises a visual element selected from the set of text, logo, graphic element, and picture.
